(19) United States
(12) Patent Application Publication
(10) Pub. No.: US 2025/0143357 A1
(43) Pub. Date: May 8, 2025

(54) BEETROOT CHIPS COATED WITH ARABIC GUM TO STABILIZE BETALAIN PIGMENT DURING DRYING AND STORAGE

(71) Applicant: KING FAISAL UNIVERSITY, Al-Ahsa (SA)

(72) Inventors: SAHAR MOSTAFA KAMEL SALEM, Al-Ahsa (SA); Randah Miqbil Alqurashi, Al-Ahsa (SA); Anoud Mohamed Alshbly, Al-Ahsa (SA)

(21) Appl. No.: 18/387,179

(22) Filed: Nov. 6, 2023

(51) Int. Cl. A23L 19/00; A23B 7/024; A23B 7/154; A23L 3/3544; A23L 19/10

(52) U.S. Cl. CPC A23L 19/05; A23B 2/771; A23B 7/024; A23B 7/154; A23L 19/10

(57) ABSTRACT

A method of making coated beetroot slices can include obtaining beetroot; washing and drying the beetroot; chopping the dried beetroot to obtain beetroot slices; dipping the beetroot slices in a solution to obtain coated beetroot slices; sieving the beetroot slices; freeze-drying the coated beetroot slices; and storing the freeze-dried coated beetroot slices. The solution can include about 1% Arabic gum solution.

### FIELD AND BACKGROUND

The disclosure of the present application relates to a method of making dried coated beetroot slices, and particularly to beetroot slices coated with Arabic gum.

### DESCRIPTION OF THE PRIOR ART

Beetroot, also known as beet, is a taproot part of the beet plant. Beetroot is a member of the flowering plant species Beta vulgaris. There are four main cultivar groups of the beetroot: garden beetroot, sugar beet, mangel-wurzel, and Swiss chard. Garden beetroot is eaten for its root and leaves. Sugar beetroot is grown for sugar production. Mangel-wurzel is used as feed for livestock. Swiss chard is cultivated for its edible leaves. About thirty percent of the world's sugar production comes from sugar beetroot.

As a food source, beetroot exhibits high nutritional value due to its high dietary source of fibers, pigments, antioxidants, vitamin C, vitamin B6, magnesium, phosphorus, iron, potassium, copper, and dietary nitrate. In the context of dietary nitrate, beetroot consumption has been associated with several health benefits, such as improvement of endothelial function, decreased blood pressure in normal and hypertensive individuals, physiological reduction of cerebral vascular resistance, increased tissue oxygenation and performance improvement, as well as increased tolerance to fatigue during physical exercise.

With all the benefits mentioned above, beetroot has been seen as a great food source for human consumption. Consumers nowadays demand high-quality, nutritious, fresh, convenient, additive-free, safe food products with a natural flavor and taste. However, it is challenging to produce beetroot as a food product which can maintain a desirable sensory profile (i.e., flavor, taste, color, crunchiness, appearance, etc.) while protecting it against oxidation.

Thus, a green, simple, sustainable, and cost-effective method for preparing beetroot food products (such as beetroot chips or slices) with the desirable properties is needed.

### SUMMARY

The present subject matter relates to a method of making coated beetroot slices with Arabic gum to improve pigment stability, color indexes, and sensory characteristics during freeze-drying and storage.

In one embodiment, the method of making coated beetroot slices includes obtaining beetroot; washing and drying the beetroot; chopping the beetroot to obtain beetroot slices; dipping the beetroot slices in an Arabic gum solution to obtain coated beetroot slices; freeze-drying the coated beetroot slices; and storing the freeze-dried coated beetroot slices.

In an embodiment, the washed beetroot can be dried with a cotton cloth.

In an embodiment, the beetroot slices can be prepared by chopping the beetroot with a food processor.

In another embodiment, the coated beetroot slices can be freeze-dried at a temperature of about −40° C. for about 48 hours.

In another embodiment, the freeze-dried coated beetroot slices can be stored at about room temperature for about 4 weeks.

In a further embodiment, the freeze-dried coated beetroot slices can include betacyanin, betaxathin, and batalain pigments.

In an embodiment, the betacyanin, betaxathin, and batalain pigments can have a concentration of about 29.79±4.76 mg/100 g, about 18.78±0.52 B mg/100 g, and about 48.57±1.28 A mg/100 g respectively during the freeze-drying step.

In an embodiment, the betacyanin, betaxathin, and batalain pigments can have a concentration of about 17.81±0.96 mg/100 g, about 18.26±1.03 mg/100 g, and about 36.07±1.97 mg/100 g respectively during the storage step.

In another embodiment, the coated beetroot slices can have an antioxidant activity percentage of about 59.37±1.34 during the storage step.

In another embodiment, the freeze-dried coated beetroot slices can include the following color indexes: L (darkness to lightness) of about 30.77±0.11, a (greenness to redness) of about 35.36±0.53, and b (blueness to yellowness) of about 2.30±0.18 during the freeze-drying step.

In another embodiment, the coated beetroot slices can have a thickness of about 1 mm to about 3 mm.

In another embodiment, the solution can include about 1% Arabic gum solution.

In an embodiment, the about 1% Arabic gum solution can be prepared by dissolving about 1 g of Arabic gum powder in about 50 mL of distilled water at about 40° C. to obtain a solution, then filtering the solution to obtain about 100 mL of about 1% Arabic gum solution.

In a further embodiment, the present subject matter relates to beetroot chips prepared by the above method.

These and other features of the present subject matter will become readily apparent upon further review of the following specification.

### DETAILED DESCRIPTION

The following definitions are provided for the purpose of understanding the present subject matter and for construing the appended patent claims. The definitions are not meant to be limiting to the subject matter described herein.

### Definitions

Throughout the application, where systems are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a system or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

The present subject matter relates to a method of preparing coated beetroot slices with Arabic gum to improve pigment stability, color indexes, and sensory characteristics during freeze-drying and storage.

In one embodiment, the method of making coated beetroot slices includes obtaining beetroot; washing and drying the beetroot; chopping the dried beetroot to obtain beetroot slices; sieving the beetroot slices; dipping the beetroot slices in a solution to obtain coated beetroot slices; freeze-drying the coated beetroot slices; and storing the freeze-dried coated beetroot slices.

In a further embodiment, the present subject matter relates to beetroot chips prepared by the above method.

In an embodiment, the method can include obtaining about 14 kg of fresh beetroot and washing the beetroot to remove any undesirable parts. The washed beetroot can be dried with a cotton cloth. The dried beetroot can be placed in a food processor to chop the beetroot into slices to obtain a thickness of about 1 mm to about 3 mm. Afterward, the beetroot slices can be placed in sieves to be sieved.

In an embodiment, about 1 g of Arabic gum powder was dissolved in about 50 mL of distilled water at about 40° C. to obtain a solution. Afterward, the solution was filtered to obtain about 100 mL of about 1% Arabic gum solution.

In an embodiment, a portion of the beetroot slices can be dipped in about 1% Arabic gum solution to form coated beetroot slices. The other portion of the beetroot slices can be set aside as a control and were not dipped in the Arabic gum solution.

In an embodiment, the coated beetroot slices and uncoated beetroot slices can be freeze dried in a freeze dryer at a temperature of about-40° C. for about 48 hours. Afterward, the freeze-dried coated beetroot slices and uncoated beetroot slices can be stored at about room temperature for about 4 weeks.

In an embodiment, the coated beetroot slices can include betacyanin, betaxathin, and batalain pigments. In an embodiment, the betacyanin, betaxathin, and batalain pigments can have a concentration of about 29.79±4.76 mg/100 g, about 18.78±0.52 B mg/100 g, and about 48.57±1.28 A mg/100 g respectively during the freeze-drying step. In certain embodiment, the betacyanin, betaxathin, and batalain pigments can have a concentration of about 17.81±0.96 mg/100 g, about 18.26±1.03 mg/100 g, and about 36.07±1.97 mg/100 g respectively during the storage step.

In an embodiment, the freeze-dried coated beetroot slices can have an antioxidant activity percentage of about 59.37±1.34 during the storage step.

In an embodiment, the freeze-dried coated beetroot slices can include the following color indexes: L (darkness to lightness) of about 30.77±0.11, a (greenness to redness) of about 35.36±0.53, and b (blueness to yellowness) of about 2.30±0.18 during the freeze-drying step.

The following examples illustrate the present teachings.

### EXAMPLES

### Example 1

### Preparation of Coated Beetroot Slices

The process of making coated beetroot slices, which are beetroot chips, was conducted using the following steps.

Collection of the beetroot: About 14 kg of fresh beetroot was collected and washed to remove any undesirable parts.

Drying of the beetroot: The washed beetroot was dried with a cotton cloth.

Chopping and sieving the beetroot: The beetroot was placed in a food processor to chop the beetroot into slices to obtain a thickness of about 1 mm to about 3 mm. Afterward, the beetroot slices were placed in sieves to get rid of excess solution.

Preparation of 1% Arabic gum solution: About 1 g of Arabic gum powder, obtained from Al-Nasr Company in Sudan, was dissolved in about 50 mL of distilled water at about 40° C. to obtain a solution. Afterward, the solution was filtered to obtain about 100 mL of about 1% Arabic gum solution.

Coating the beetroot slices: A portion of the beetroot slices were dipped in about 1% Arabic gum solution to form coated beetroot slices. The other portion of the sieved beetroot slices were set aside as a control and were not dipped in the Arabic gum solution.

Freeze-drying: The coated beetroot slices and uncoated beetroot slices were freeze-dried in a freeze dryer at a temperature of about-40° C. for about 48 hours.

Storing: The freeze-dried coated beetroot slices and uncoated beetroot slices were stored at about room temperature for about 4 weeks.

### Example 2

### Effect of Coating on Beetroot Pigments Stability During Freeze-Drying

Compared with the uncoated beetroot slices (control), the coated beetroot slices exhibited better stability of the betacyanin and betalain pigments during freeze-drying as shown in Table 1 below.

TABLE 1

| Pigments (mg/100 g) | | | |
|---|---|---|---|
| Mg/100 g = pigment | | | |
| concentration | Betacyanin | Betaxanthin | Betalain |
| Uncoated freeze-dried | 28.94 ± 2.91 | 19.51 ± 1.92 | 47.80 ± 1.01 |
| beetroot slices (chips) | | | |
| Coated freeze-dried | 29.79 ± 4.76 | 18.78 ± 0.52 | 48.57 ± 1.28 |
| beetroot slices (chips) | | | |

### Example 3

### Effect of Coating on Beetroot Color Indexes During Freeze-Drying

Compared with the uncoated beetroot slices (control), the coated beetroot slices exhibited better color indexes (L, a, b) during freeze-drying as shown in Table 2 below.

TABLE 2

| Color indexes | L | a | b |
|---|---|---|---|
| Uncoated freeze-dried | 28.29 ± 0.46 | 32.32 ± 1.20 | 2.83 ± 0.35 |
| beetroot slices (chips) | | | |
| Coated freeze-dried | 30.77 ± 0.11 | 35.36 ± 0.53 | 2.30 ± 0.18 |
| beetroot slices (chips) | | | |

### Example 4

### Effect of Coating on Sensory Characteristics of Freeze-Dried Beetroot Slices (Chips)

Compared with the uncoated beetroot slices (control), the coated beetroot slices exhibited no significant difference in sensory characteristics (flavor, taste, color, crunchy, appearance, acceptability) during freeze-drying as shown in Table 3 below.

TABLE 3

| | | | | | | |
|---|---|---|---|---|---|---|
| Method | Flavor | Taste | Color | Crunchy | Appearance | Acceptability |

Uncoated freeze-dried beetroot slices (chips)

| | | | | | |
|---|---|---|---|---|---|
| 4.00 ± 0.0 | 4.70 ± 2.56 | 4.60 ± 0.0 | 3.70 ± 2.56 | 4.40 ± 0.0 | 4.70 ± 1.56 |

Coated freeze-dried beetroot slices (chips)

| | | | | | |
|---|---|---|---|---|---|
| 4.60 ± 0.0 | 4.71 ± 0.0 | 4.57 ± 0.0 | 4.20 ± 2.56 | 4.30 ± 1.56 | 4.75 ± 1.56 |

### Example 5

### Effect of Coating on Freeze-Dried Beetroot Pigments Stability & Antioxidant Activity During Storage

Compared with the uncoated freeze-dried beetroot slices (control), the coated freeze-dried beetroot slices exhibited better overall stability of the betacyanin, betaxanthin, and betalain pigments for the entire duration of storage. Additionally, the coated freeze-dried beetroot slices showed better antioxidant activity than the uncoated freeze-dried beetroot slices for the second and fourth weeks of storage. These data are shown in Table 4 below.

TABLE 4

| | | | | |
|---|---|---|---|---|
| | | | | Antioxidant |
| Weeks | Betacyanin | Betaxanthin | Betalain | activity % |

Uncoated freeze-dried beetroot slices (chips)

| | | | | |
|---|---|---|---|---|
| 0 | 19.12 ± 0.93 | 13.66 ± 1.95 | 32.78 ± 6.34 | 70.92 ± 0.12 |
| 2 | 16.65 ± 0.16 | 11.55 ± 0.18 | 28.20 ± 0.34 | 56.69 ± 1.68 |
| 4 | 16.33 ± 0.59 | 10.82 ± 0.18 | 27.15 ± 0.73 | 54.22 ± 0.68 |

Coated freeze-dried beetroot slices (chips)

| | | | | |
|---|---|---|---|---|
| 0 | 20.13 ± 0.16 | 13.92 ± 0.15 | 34.06 ± 0.32 | 69.78 ± 1.19 |
| 2 | 18.97 ± 0.84 | 17.38 ± 1.08 | 36.28 ± 1.67 | 60.56 ± 1.28 |
| 4 | 17.81 ± 0.96 | 18.26 ± 1.03 | 36.07 ± 1.97 | 59.37 ± 1.34 |

It is to be understood that the method for preparing an adsorbent from palm fiber char and at least one polymer is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method of making coated beetroot slices, the method comprising:
obtaining beetroot;
washing and drying the beetroot;
chopping the beetroot to obtain beetroot slices;
preparing a solution by dissolving Arabic gum powder in water to provide a solution consisting of Arabic gum powder and water;
dipping the beetroot slices in the solution to obtain coated beetroot slices;
sieving the beetroot slices;
freeze-drying the coated beetroot slices; and
storing the freeze-dried coated beetroot slices, wherein the freeze-dried coated beetroot slices are stored at about room temperature for about 4 weeks.

2. The method of making coated beetroot slices of claim 1, wherein the washed beetroot is dried with a cotton cloth.

3. The method of making coated beetroot slices of claim 1, wherein the beetroot slices are prepared by chopping the dried beetroot with a food processor.

4. The method of making coated beetroot slices of claim 1, wherein the coated beetroot slices are freeze-dried at a temperature of about −40° C. for about 48 hours.

5. (canceled)

6. The method of making coated beetroot slices of claim 1, wherein the coated beetroot slices comprise of betacyanin, betaxathin, and batalain pigments.

7. The method of making coated beetroot slices claim 6, wherein the betacyanin, betaxathin, and batalain pigments have a concentration of about 29.79±4.76 mg/100 g, about 18.78±0.52 B mg/100 g, and about 48.57±1.28 A mg/100 g respectively during the freeze-drying step.

8. The method of making coated beetroot slices claim 6, wherein the betacyanin, betaxathin, and batalain pigments have a concentration of about 17.81±0.96 mg/100 g, about 18.26±1.03 mg/100 g, and about 36.07±1.97 mg/100 g respectively during the storage step.

9. (canceled)

10. The method of making coated beetroot slices of claim 1, wherein the coated beetroot slices comprise of the following color indexes: L (darkness to lightness) of about 30.77±0.11, a (greenness to redness) of about 35.36±0.53, and b (blueness to yellowness) of about 2.30±0.18 during the freeze-drying step.

11. The method of making coated beetroot slices of claim 1, wherein the coated beetroot slices have a thickness of about 1 mm to about 3 mm.

12. (canceled)

13. The method of making coated beetroot slices of claim 1, wherein the solution is prepared by dissolving about 1 g of Arabic gum powder in about 50 mL of distilled water at about 40° C. to obtain the solution.

14. (canceled)
